(19) United States
(12) Patent Application Publication
(10) Pub. No.: US 2023/0330867 A1
(43) Pub. Date: Oct. 19, 2023

(54) ROBOT HAND AND METHOD FOR GRIPPING CONNECTOR-EQUIPPED HARNESS

(71) Applicant: FANUC CORPORATION, Yamanashi (JP)

(72) Inventor: Yoshihito OOAGU, Yamanashi (JP)

(21) Appl. No.: 18/014,083

(22) PCT Filed: Jul. 12, 2021
(86) PCT No.: PCT/JP2021/026076

§ 371 Date: Jun. 21, 2023

(30) Foreign Application Priority Data
Jul. 17, 2020 (JP) 2020-122742

(51) Int. Cl. B25J 15/00; B25J 19/02; B25J 9/16

(52) U.S. Cl. CPC B25J 15/0019; B25J 19/023; B25J 9/1697

(57) ABSTRACT

It is desired to be able to grip a connector at a predetermined position in a predetermined orientation, and to be able to insert the connector into a connector port located in a narrow space. A robot hand 1 includes: a hand base 11; a push mechanism 20 supported by the hand base so as to be movable back and forth and configured to press a connector from above; a front-stage wire rod chuck mechanism 30 supported by the hand base so as to be movable up and down and back and forth and configured to pinch a harness; a rear-stage wire rod chuck mechanism 50 supported by the hand base so as to be movable up and down and configured to pinch the harness; and a pair of pressing parts 41, 42 provided on a pair of fingers 31, 32 of the front-stage wire rod chuck mechanism and configured to be pressed against the connector from behind.

### TECHNICAL FIELD

The present invention relates generally to a robot hand and a method for gripping a connector-equipped harness.

### BACKGROUND ART

Various assembly processes are being automated through the use of robots. One difficult process among these processes is a process of inserting a connector into a connector port. In order for a robot hand to grip a harness or a connector and correctly insert it into a connector port, the robot hand needs to grip the connector at a predetermined position in a predetermined orientation.

A complicated jig is required to supply a connector and a harness to a predetermined position in a predetermined orientation with respect to a robot hand. It is also possible to use a camera to capture an image of a connector and a harness supplied in a relatively free state and, based on the camera image, control the approaching direction of the hand to the connector and its orientation and posture so as to grip the connector in a predetermined orientation and at a predetermined position. However, it may be difficult due to the posture of the robot arm or the structure of the hand.

Patent Literature 1 discloses a robot hand that directly pinches a coupler (connector) with a pair of chucks. However, with the structure in which the connector is directly pinched, the hand is wider than the connector in the state of gripping the connector. Therefore, in cases where the connector port is located in a narrow space, the hand may interfere with the surroundings and may not be able to insert the connector into the connector port.

### CITATION LIST

### Patent Literature

Patent Literature 1: Japanese Unexamined Patent Application Publication No. 06-188061

### SUMMARY OF INVENTION

### Technical Problem

There is a need for a hand that can grip a connector at a predetermined position in a predetermined orientation and can insert the connector into a connector port located in a narrow space.

### Solution to Problem

A robot hand for gripping a harness according to one aspect of the present disclosure includes: a hand base; a push mechanism supported by the hand base so as to be movable back and forth and configured to press a connector from above; a front-stage wire rod chuck mechanism supported by the hand base so as to be movable up and down and back and forth and configured to pinch the harness; a rear-stage wire rod chuck mechanism supported by the hand base so as to be movable up and down and configured to pinch the harness; and a pair of pressing parts provided on a pair of fingers of the front-stage wire rod chuck mechanism and configured to be pressed against the connector from behind. The push mechanism presses the connector onto a table to make the connector horizontal to the table, the rear-stage wire rod chuck mechanism pinches the harness, and the front-stage wire rod chuck mechanism pinches and holds the harness in a state where the front-stage wire rod chuck mechanism is moved forward and the pressing parts are pressed against the connector.

### Advantageous Effects of Invention

The connector can be gripped at a predetermined position in a predetermined orientation, and can be inserted into a connector port located in a narrow space.

### BRIEF DESCRIPTION OF THE DRAWINGS

FIG. 1 is a side view showing a robot equipped with a robot hand according to the present embodiment.

FIG. 2 is a perspective view showing an example of the robot hand shown in FIG. 1.

FIG. 3 is a partially omitted side view of the robot hand shown in FIG. 2.

FIG. 4 is a partially omitted plan view of the robot hand shown in FIG. 2.

FIG. 5 shows a first stage of a gripping operation by the robot hand shown in FIG. 2.

FIG. 6 shows a second stage of the gripping operation by the robot hand shown in FIG. 2.

FIG. 7 shows a third stage of the gripping operation by the robot hand shown in FIG. 2.

FIG. 8 shows a fourth stage of the gripping operation by the robot hand shown in FIG. 2.

FIG. 9 shows a fifth stage of the gripping operation by the robot hand shown in FIG. 2.

FIG. 10 shows another example of pressing parts of the robot hand according to the present embodiment.

FIG. 11 shows another example of first fingers of the robot hand according to the present embodiment.

FIG. 12 is a side view showing another example of the attachment position of a camera of the robot hand according to the present embodiment.

### DETAILED DESCRIPTION

Hereinafter, a robot hand according to the present embodiment will be described with reference to the drawings. The robot hand according to the present embodiment is used for gripping a harness with a connector connected at its tip. Typically, the robot hand is attached to the arm tip of various types of robot arm mechanisms such as vertically articulated type, horizontally articulated type, and polar coordinate type. In the following description, constituent elements having substantially the same function and configuration are denoted by the same reference numeral, and a repetitive description will be given only where necessary.

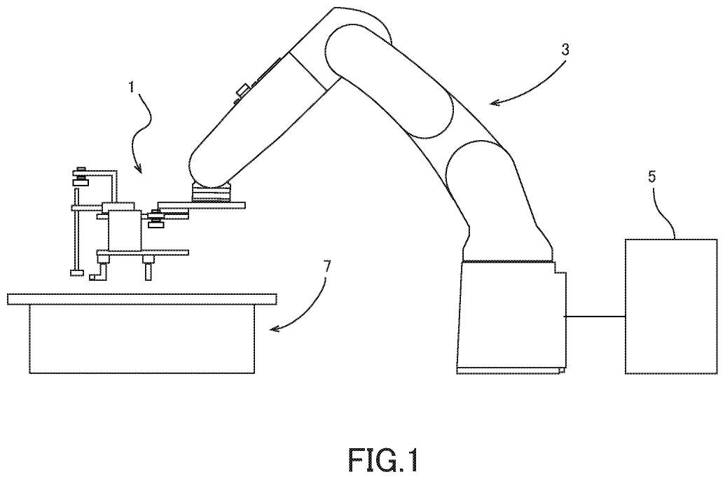

As shown in FIG. 1, a robot hand 1 is used by being attached to the wrist at the leading end of a robot arm mechanism 3. The robot arm mechanism 3 and the robot hand 1 are controlled by a controller 5. The controller 5 includes a storage device, such as an HDD, storing a gripping program for controlling a gripping operation of the robot hand 1, an arithmetic processing device, such as a CPU, for executing the program stored in the storage device, and the like. By the arithmetic processing device executing the gripping program, the robot hand 1 operates together with the robot arm mechanism 3 in accordance with a gripping sequence specified by the gripping program, so that a connector-equipped harness can be gripped.

### Robot Hand

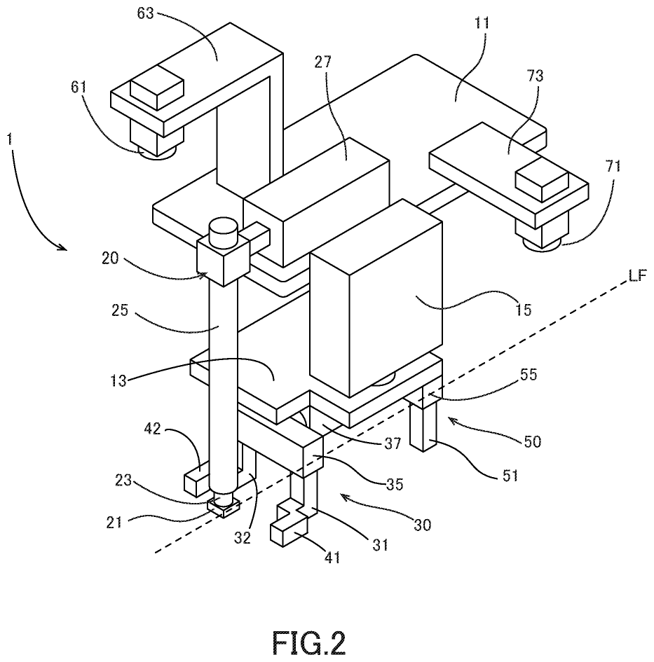

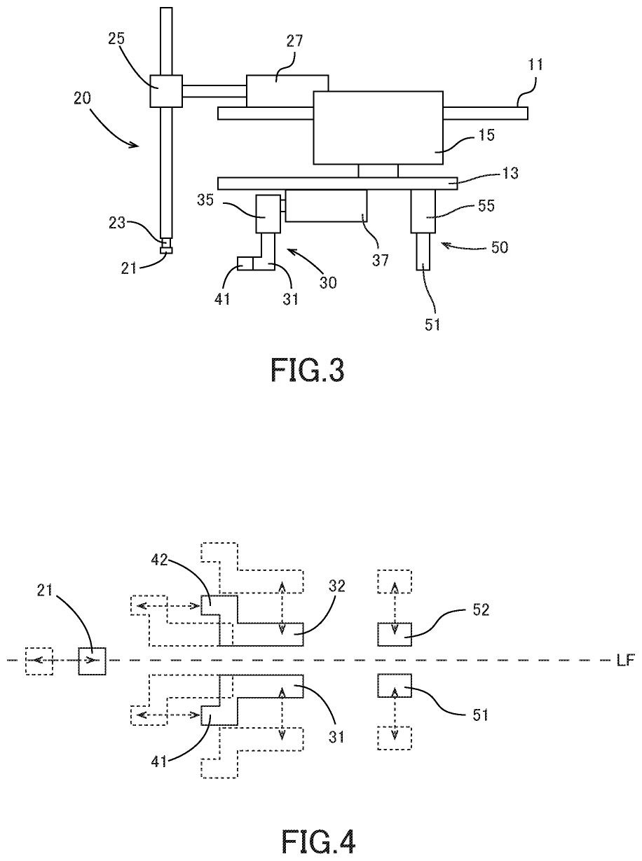

Hereinafter, a configuration of the robot hand 1 for gripping a harness will be described with reference to FIGS. 2 to 4. FIG. 2 is a perspective view of the front side of the robot hand 1. FIG. 3 is a side view of the robot hand 1. FIG. 4 is a plan view of the robot hand 1. In FIG. 3, a connector detection camera 61 and an overall detection camera 71 are omitted in order to clarify the main constituent elements of the robot hand 1. In FIG. 4, in order to clarify the positional relationship between a pad 21 of a push mechanism 20, a pair of first fingers 31, 32 in the front stage, and a pair of second fingers 51, 52 in the rear stage, the other constituent elements are omitted.

As shown in FIGS. 2 and 3, the robot hand 1 has a rectangular plate-shaped hand base 11. In the following description, the longitudinal direction of the hand base 11 is referred to as a front-rear direction, the lateral direction of the hand base 11 is referred to as a left-right direction, and the thickness direction of the hand base 11 is referred to as an up-down direction.

The hand base 11 is provided with a connector detection camera 61 for photographing a connector and an overall detection camera 71 for photographing a connector-equipped harness from above. The connector detection camera 61 is provided in front of the hand base 11 via a camera mount 63 such that the photographing direction faces downward. The overall detection camera 71 is provided on the side of the hand base 11 via a camera mount 73 such that the photographing direction faces downward.

The hand base 11 supports a push mechanism 20 for pressing a connector mounted on a table 7 from above, and two wire rod chuck mechanisms 50, 30 for pinching a harness.

The push mechanism 20 has a cylindrical push pin 23 and a pin lifting mechanism 25 for raising and lowering the push pin 23 in the up-down direction. Typically, a pad 21 made of an elastic resin for making contact with the connector is attached to the tip of the push pin 23. The push mechanism 20 is connected to a front portion of the hand base 11 via a first back-and-forth movement mechanism 27. The push mechanism 20 may be fixed to the hand base 11 without the first back-and-forth movement mechanism 27.

A rectangular plate-shaped chuck base 13 is connected to the hand base 11 via a base lifting mechanism 15. The chuck base 13 is arranged below the hand base 11, in parallel with the hand base 11. Two wire rod chuck mechanisms 30, 50 are supported by the chuck base 13. The two wire rod chuck mechanisms 30,50 are arranged at positions separated from each other in the front-rear direction. The two wire rod chuck mechanisms 30, 50 may be connected to separate lifting mechanisms.

The front-stage wire rod chuck mechanism 30 is connected to the chuck base 13 via a second back-and-forth movement mechanism 37. The front-stage wire rod chuck mechanism 30 has a pair of first fingers 31, 32 and a first opening/closing mechanism 35 for opening and closing the pair of first fingers 31, 32 in the left-right direction. Typically, the pair of first fingers 31, 32 have an L-shaped outer shape, and are attached to the first opening/closing mechanism 35 such that they are parallel to each other along the up-down and front-rear directions and such that their tips face forward. A pair of pressing parts 41, 42 which are pressed against the connector from behind are formed integrally on the pair of first fingers 31, 32, respectively. Typically, the pair of pressing parts 41, 42 each have an outwardly widened L-shaped planar shape, and are connected to the tips of the pair of first fingers 31, 32, respectively, so that the pair of pressing parts 41, 42 as a whole constitute a U-shaped planar shape.

The rear-stage wire rod chuck mechanism 50 has a pair of second fingers 51, 52 and a second opening/closing mechanism 55 for opening and closing the pair of second fingers 51, 52 in the left-right direction. Typically, the pair of second fingers 51, 52 have a rod-like outer shape and are attached to the second opening/closing mechanism 55 in parallel with each other along the up-down direction.

As shown in FIG. 4, the push mechanism 20, the front-stage wire rod chuck mechanism 30, and the rear-stage wire rod chuck mechanism 50 are positioned so that the center position of the pad surface of the pad 21 brought into contact with the connector, the opening/closing center position of the pair of first fingers 31, 32 of the front-stage wire rod chuck mechanism 30, and the opening/closing center position of the pair of second fingers 51, 52 of the rear-stage wire rod chuck mechanism 50 are arranged on a reference line LF of the robot hand 1 extending in the front-rear direction.

### Gripping Procedure

Referring to FIGS. 5 to 9, the procedure for gripping a connector-equipped harness A using the robot hand 1 according to the present embodiment will be described below. First, a connector B and a harness C are detected from an overall image captured by the overall detection camera 71, and the robot hand 1 is moved by the robot arm mechanism 3 so that the opening/closing centers of the two chuck mechanisms 30, 50 are arranged above the harness C.

As shown in FIG. 5, the two wire rod chuck mechanisms 30, 50 are lowered by the base lifting mechanism 15. Thus, the front portion of the harness C can be surrounded by the pair of first fingers 31, 32 of the front-stage wire rod chuck mechanism 30, and the rear portion of the harness C can be surrounded by the pair of second fingers 51, 52 of the rear-stage wire rod chuck mechanism 50. At this time, the connector B is positioned on the reference line LF. Next, the connector B is detected from a connector image captured by the connector detection camera 61, and the front-rear position of the push mechanism 20 is adjusted by the first back-and-forth movement mechanism 27.

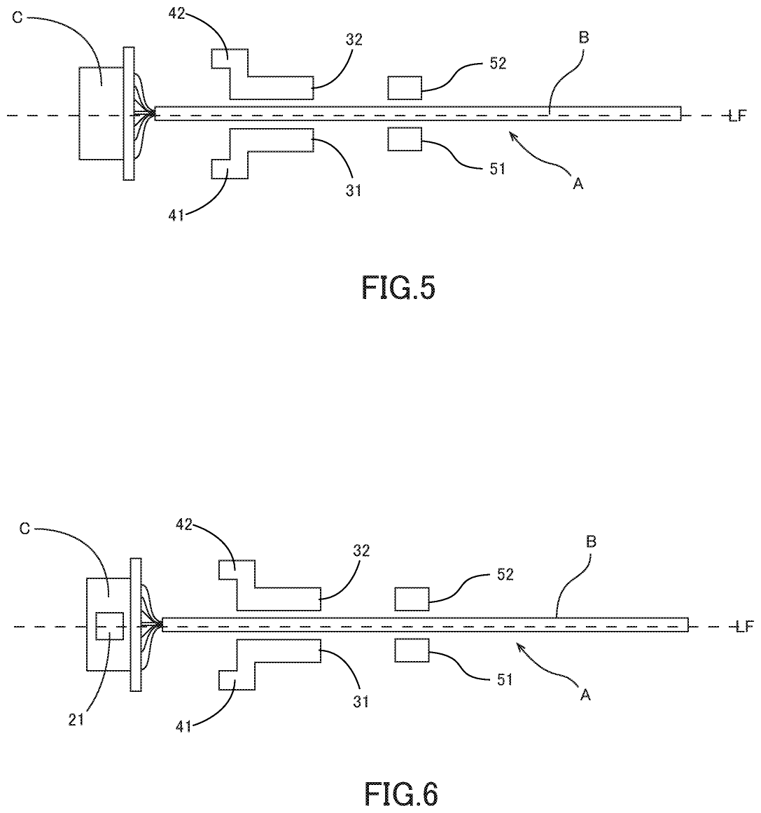

As shown in FIG. 6, after the position of the push mechanism 20 is adjusted, the push pin 23 is lowered by the pin lifting mechanism 25. Thus, the connector B is pressed against the table 7 by the pad 21 (push pin 23). The lower surface of the connector B pressed against the table 7 is parallel to the mounting surface of the table 7.

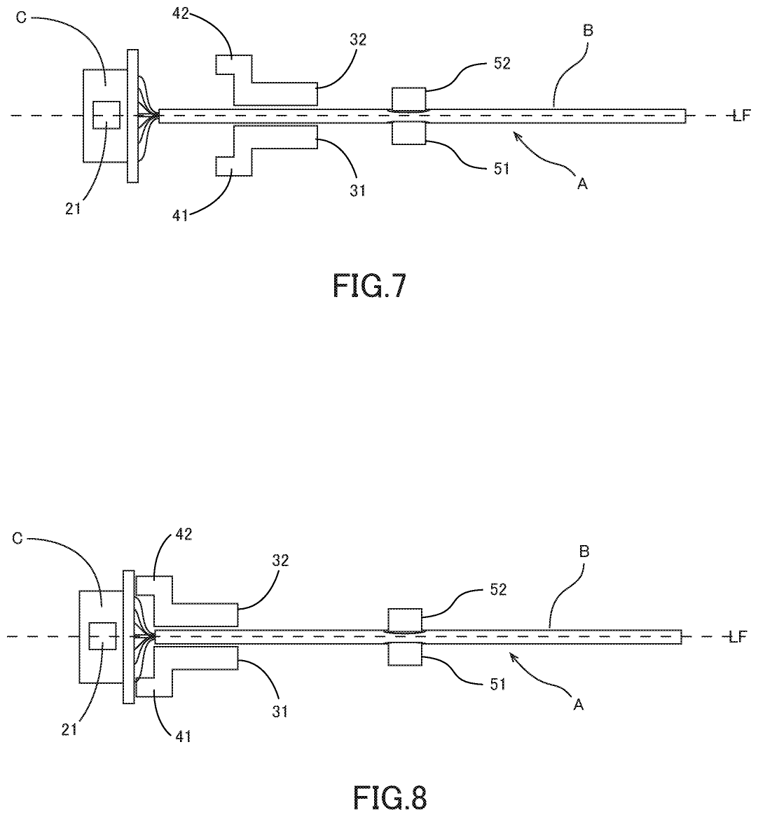

As shown in FIG. 7, the second opening/closing mechanism 55 of the rear-stage wire rod chuck mechanism 50 is closed, and the harness C is pinched and held by the pair of second fingers 51, 52.

As shown in FIG. 8, in the state where the harness C is held by the pair of second fingers 51, 52, the front-stage wire rod chuck mechanism 30 is moved forward by the second back-and-forth movement mechanism 37, and the pair of pressing parts 41, 42 are pressed against the rear end surface of the connector B. Thus, the position and orientation of the connector B with respect to the position where the harness C is pinched by the pair of second fingers 51, 52 can be fixed.

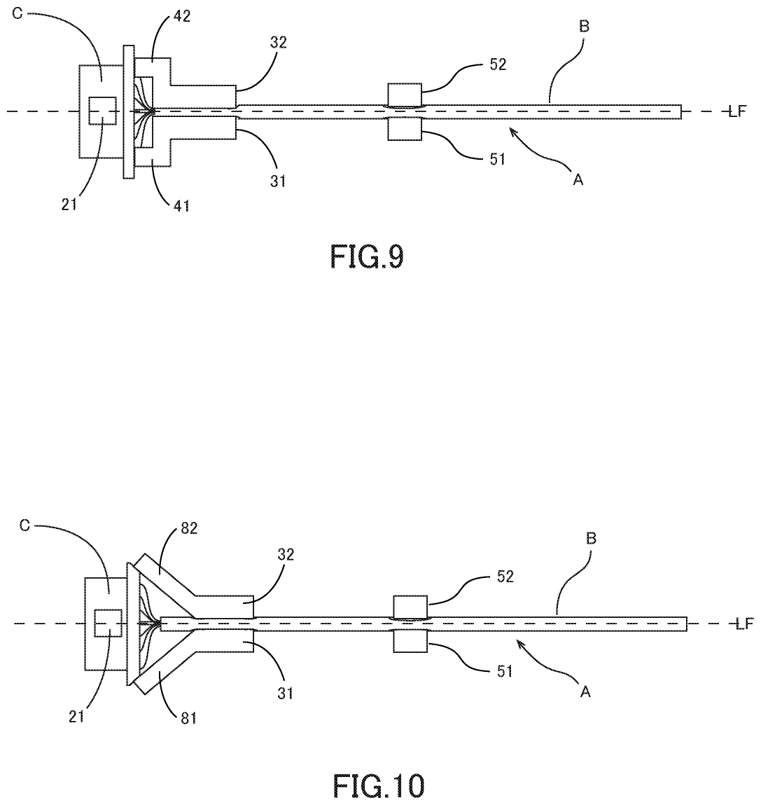

As shown in FIG. 9, the first opening/closing mechanism 35 of the front-stage wire rod chuck mechanism 30 is closed, and the harness C is pinched by the pair of first fingers 31, 32.

By the gripping procedure described above, the robot hand 1 can grip the connector-equipped harness A using the two wire rod chuck mechanisms 30, 50. The orientation of the connector B of the connector-equipped harness A gripped by the robot hand 1 may be misaligned with respect to a specified orientation. Therefore, it is desirable that the connector B of the connector-equipped harness A gripped by the robot hand 1 is photographed by the connector detection camera 61 and, based on the captured connector image, the misalignment amount of the orientation of the connector B with respect to the specified orientation is detected. The connector B of the connector-equipped harness A can be inserted into the connector port with high accuracy by correcting the orientation of the robot hand 1 when the connector-equipped harness A gripped by the robot hand 1 is inserted into the connector port on the basis of the detected misplacement amount of the orientation of the connector B.

### Advantageous Effects

The robot hand 1 according to the present embodiment described above can grip a connector-equipped harness by pressing the pair of pressing parts 41, 42 connected to the pair of first fingers 31, 32 of the first-stage wire rod chuck mechanism 30 against the rear end surface of the connector while pinching the harness with the pair of first fingers 31, 32 of the front-stage wire rod chuck mechanism 30 and the pair of second fingers 51, 52 of the rear-stage wire rod chuck mechanism 50. The connector can be held in a state of being almost entirely exposed except for the rear end surface thereof and projecting from the tips of the first fingers 31, 32. The first fingers 31, 32 do not project outward beyond the width of the connector, or slightly project even when they do, because the connector is not pinched on both sides. According to the robot hand 1 according to the present embodiment, a connector can be inserted into a connector port located in a narrow place. Further, in the process of gripping the connector-equipped harness, the connector mounted on the table is pressed from above by the push pin 23 and temporarily fixed. In the state where the outer surface of the connector brought into contact with the surface of the table is horizontal, the gripping operation of the connector-equipped harness is started. In other words, the gripping operation of the connector-equipped harness is always executed in a state where the connector is in the same posture, the connector can be gripped at a predetermined position in a predetermined orientation. Even if the orientation of the connector is misaligned with respect to a specified orientation, the influence of the misalignment can be easily eliminated by detecting the amount of the misalignment and correcting the orientation of the robot hand 1 when the connector is inserted into the connector port.

The pair of pressing parts 41, 42 can have any shape in accordance with the size and shape of the target connector. As shown in FIG. 10, for example, the pair of pressing parts 81, 82 may be formed to have a Y-shaped planar shape that widens forward as a whole.

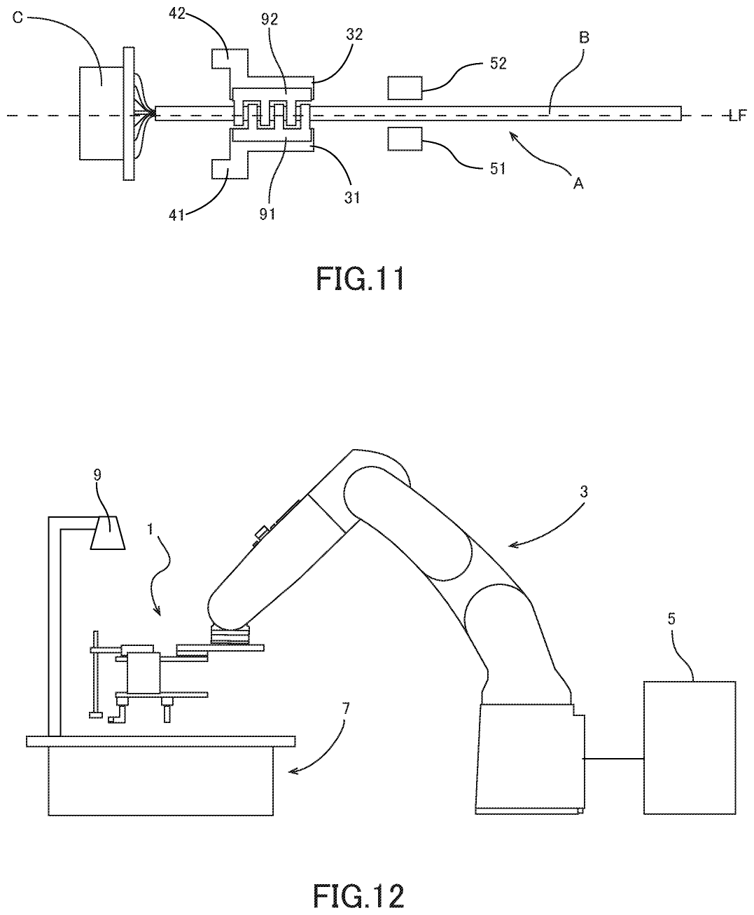

Further, in order to align the harness C curved to bulge upward with respect to the surface of the table 7 as straight as possible, a pair of covers 91, 92 may be provided on the pair of first fingers 31, 32. As shown in FIG. 11, for example, the pair of covers 91, 92 are formed in comb shapes alternately fitted into each other. As a result, the bulge of the harness C can be restrained within the height of the pair of first fingers 31, 32, and the gripping accuracy of the connector-equipped harness by the robot hand 1 can be improved.

Although the robot hand 1 is equipped with two cameras 61, 71 in the present embodiment, it may be provided with one camera. Further, as shown in FIG. 12, instead of the robot hand 1 being equipped with a camera, one camera may be provided at a position overlooking the place on the table 7 where the connector-equipped harness is mounted.

In addition, the configuration is not limited to the one in the present embodiment as long as the pair of pressing parts 41, 42 can be pressed against the rear end surface of the connector in the state where the harness is pinched. For example, although the robot hand 1 is provided with the two wire rod chuck mechanisms 30, 50 in the present embodiment, it may be provided with three or more wire rod chuck mechanisms. Alternatively, the robot hand 1 may have a single wire rod chuck mechanism for pinching the harness and a mechanism for pressing a pressing part against the rear end surface of the connector.

While some embodiments of the present invention have been described, these embodiments have been presented as examples, and are not intended to limit the scope of the invention. These embodiments can be implemented in various other forms, and various omissions, replacements, and changes can be made without departing from the spirit of the invention. These embodiments and their modifications are included in the scope and spirit of the invention and are included in the scope of the claimed inventions and their equivalents.

### EXPLANATION OF REFERENCE NUMERALS

1: robot hand, 11: hand base, 13: chuck base, 15: base lifting mechanism, 20: push mechanism, 21: pad, 23: push pin, 25: pin lifting mechanism, 27: first back-and-forth movement mechanism, 30: front-stage wire rod chuck mechanism, 31, 32: first finger, 35: first opening/closing mechanism, 37: second back-and-forth movement mechanism, 41, 42: pressing part, 50: rear-stage wire rod chuck mechanism, 51, 52: second finger, 55: second opening/closing mechanism, 61: connector detection camera, 63: camera mount, 71: overall detection camera, 73: camera mount

1. A robot hand configured to grip a harness with a connector connected to a tip thereof, the robot hand comprising:
a hand base;
a push mechanism supported by the hand base so as to be movable back and forth and configured to press the connector onto a table from above;
a front-stage wire rod chuck mechanism supported by the hand base so as to be movable up and down and movable back and forth and configured to pinch the harness;
a rear-stage wire rod chuck mechanism supported by the hand base so as to be movable up and down and configured to pinch the harness; and
a pair of pressing parts provided on a pair of fingers of the front-stage wire rod chuck mechanism and pressed against the connector from behind, wherein
the push mechanism presses the connector onto the table to make the connector horizontal to the table, and
the rear-stage wire rod chuck mechanism pinches the harness, and
the front-stage wire rod chuck mechanism pinches and holds the harness in a state where the front-stage wire rod chuck mechanism is moved forward and the pressing parts are pressed against the connector.

2. The robot hand according to claim 1, further comprising a connector detection camera mounted on the hand base to photograph the connector.

3. The robot hand according to claim 1 or 2, further comprising an overall detection camera mounted on the hand base to photograph the harness and the connector from above.

4. The robot hand according to any one of claims 1 to 3, wherein the pressing parts have a Y-shaped outer shape that widens forward.

5. The robot hand according to any one of claims 1 to 3, wherein the pressing parts have a U shape.

6. The robot hand according to any one of claims 1 to 5, wherein a pair of comb-shaped covers that alternately fitted into each other are attached to the pair of fingers of the front-stage wire rod chuck mechanism in order to restrain a curvature of the harness within a height of the fingers.

7. A method for gripping a connector-equipped harness configured to grip the harness with a connector connected at a tip thereof, the method comprising:
detecting a position of the harness based on an image captured by a camera mounted on a hand base or provided outside;
moving the hand base in accordance with the detected position of the harness, and surrounding the harness with a pair of fingers of each of a front-stage wire rod chuck mechanism and a rear-stage wire rod chuck mechanism supported by the hand base;
detecting a position of the connector based on an image captured by another camera mounted on the camera or the hand base or provided outside;
moving back and forth a push mechanism supported by the hand base in accordance with the detected position of the connector, and lowering a push pin of the push mechanism to press the connector onto a table;
pinching the harness with the pair of fingers of the rear-stage wire rod chuck mechanism;
moving the front-stage wire rod chuck mechanism forward and pressing a pair of pressing parts provided on the pair of fingers of the front-stage wire rod chuck mechanism against the pressed connector from behind;
pinching the harness with the pair of fingers of the front-stage wire rod chuck mechanism; and
retracting the push pin and the rear-stage wire rod chuck mechanism from the connector and the harness.
